(19) United States
(12) Patent Application Publication
(10) Pub. No.: US 2005/0168965 A1
(43) Pub. Date: Aug. 4, 2005

(54) Electronic lighting unit and photographic equipment with the electronic lighting unit

(75) Inventor: Hideo Yoshida, Saitama-Shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/047,969

(22) Filed: Feb. 2, 2005

(30) Foreign Application Priority Data
Feb. 2, 2004 (JP) 2004-025745

(51) Int. Cl. G03B 15/02; E05B 17/10

(52) U.S. Cl. 362/3

(57) ABSTRACT

A lighting unit for producing flash light toward subjects in a photographic scene comprises an matrix array of light emitting elements arranged so as to have individual lighting fields different from one another, a selective excitation circuit for exciting selectively the light emitting elements so as to produce flash light, different in intensity as appropriate, in predetermined lighting patterns and an excitation/extinction circuit 250 for exciting or extinguishing the light emitting elements. A photographic equipment equipped with the lighting unit has directive switches or buttons for directing the lighting unit to select lighting pattern according to focal lengths, zoom rations, operation modes including a communication mode, and/or demands of pre-lighting,

### BACKGROUND OF THE INVENTION

1. Field of the invention

The present invention relates to a lighting unit, and, more particularly, a lighting unit comprising a plurality of light emitting elements, and a photographic equipment with the lighting unit built therein.

2. Description of Related Art

Typically, one of photographic lighting or flash devices for subsidiarily lighting subjects that are most popular in the art is an electronic flash device. Such an electronic flash device is such that, when a high voltage stored in the capacitor is applied to the gas-discharge tube, the gas inside becomes ionized and then a rush of current flows through the gas the tube and it simultaneously emits a bright light by sudden discharge.

Meanwhile, cellular phones with an images import feature that have recently been in widespread use are generally provided with lighting devices for lighting a subject to be imported. In general, such a lighting device built in the cellular phones comprises a single piece of white light emitting diode (white LED) for the purpose of space-saving. The cellular phone image import system is designed so that, in the event of taking a picture under, for example, illumination in a room weaker in emission intensity than daylight, the white LED is kept excited by operating a first button so as to illuminate an aimed subject and then a shooting is made by operating a second button to import an image of the subject.

Various types of electronic flash devices have been known in a photographic art. For example, Japanese Unexamined Patent Publication Nos. 3-50538, 4-285930 and 5-93946 disclose electronic flash devices that have a mechanism for changing its direction of lighting according to focal length or zoom ratios of a zoom lens of a camera. Japanese Unexamined Patent Publication No. 6-326914 discloses an electronic flash device that has a mechanism for changing its direction of lighting according to electronic zoom or trimming ratios. Japanese Unexamined Patent Publication No. 8-292469 discloses a multi-split flash device comprising a plurality of flash elements that are individually varied in their directions of lighting by means of a varying mechanism. Japanese Unexamined Utility Model Publication No. 1-67629 discloses a multi-bulb electronic flash device having a plurality of flash bulbs parallelized to divisions of an image plane that extinguishes a flash bulb when a proper luminance of a division corresponding to the flash bulb is reached. Japanese Unexamined Patent Publication No. 2001-245205 discloses an image pickup equipment provided with a wide-area lighting device and a narrow-area lighting device which have individual emission intensity distributions coincide with each other at a enter of an imaging area. The image pickup equipment changes a ratio of emission intensity between the wide-area lighting device and the narrow-area lighting device according to zoom ratios so as thereby to provide an image with less occurrence of brightness irregularity.

When designing light and thin, more compact image pickup devices, it is advantageous to employ white light emitting diodes (LEDs) as compared with electronic flash bulbs, a single piece of white LED encounters a problem such that light the white LED emits is too low in emission intensity to make correct exposure in a dark scene. It is one approach to a solution of the problem of emission intensity to excite a plurality of white LEDs simultaneously. However, this simultaneous excitation encounters another problem that electric power consumption increases according to the number of excited white LEDs. In particular, in the case where the single piece of white LED is installed in cellular phones having an optical communication feature in addition to the image import feature, if the white LED elements can produce high intensity of light, the cellular phone will be disabled to make calls and/or data communication due to a potential drop of batteries resulting from image import. That is, there are two somewhat conflicting requirements that govern reliable lighting by simultaneous excitation of the white LEDs and power saving in opposition to simultaneous excitation of the white LEDs.

The mechanisms for changing a direction of lighting which the conventional lighting devices are equipped with are hardly downsized due to an inevitable increase in the number of parts. The multi-bulb electronic flash device having a plurality of flash bulbs that extinguishes individually the flash bulb for avoiding an occurrence of brightness irregularities admits of seeking efficiency and downsizing. Further, the wide-area lighting device and the narrow-area lighting device of the image pickup equipment which have individual emission intensity distributions coincide with each other at a center of a lighting extent should inevitably be excited for avoiding an occurrence of brightness irregularities.

### SUMMARY OF THE INVENTION

It is therefore an object of the present invention to provide a lighting unit comprising a plurality of light emitting elements allowed to be excited simultaneously and a photographic equipment with the lighting unit built therein.

It is another object of the present invention to provide a lighting unit comprising a plurality of light emitting elements that measures up reliable lighting efficiency and ensured power saving.

According to one aspect of the present invention, the foregoing objects are accomplished by a lighting unit for producing flash light toward a subject in a photographic scene, which comprises a plurality of light emitting elements, preferably light emitting diodes, arranged so as to have individual lighting fields different from one another, and selective excitation mean for exciting selectively the light emitting elements so as to produce flash light in predetermined different lighting patterns. The selective excitation mean is preferred to excite selected light emitting elements to produce flash light altered in intensity.

According to the configuration, since it is ensured that only light emitting elements selected to comply with an intended lighting pattern are excited, the lighting unit produces light efficiently for subjects and makes for power saving as well.

According to another aspect of the present invention, the foregoing objects are accomplished by a photographic equipment that comprises an image pickup system operative to form an optical image of a subject on image pickup means, such as a charge coupled device (CCD) or a silver salt film, through a taking lens, and the lighting unit including the selective excitation mean as described above. The photographic equipment further comprises lighting pattern directive means for directing the selective excitation mean to excite the light emitting elements selectively to produce flash light in predetermined different lighting patterns. The photographic equipment can be embodied in, for example, digital still cameras with or without at least one of optical and electronic zooming features, digital video cameras, cellular phones with an image import feature, and conventional cameras for use with silver salt films.

The lighting pattern directive means is preferred to direct the selective excitation mean to excite selectively the light emitting elements to produce flash light in predetermined different lighting patterns according to at least one of optical and electronic zoom ratios of the image pickup system. In this instance, the electronic zoom ratio as used herein shall mean and refer to a ratio (a trimming ratio or an extraction ratio) of a trimming or extraction image area relative to a given image area of the image pickup device. This configuration causes the lighting unit to produce flash light efficiently for subjects.

The lighting pattern directive means is further preferred to direct the selective excitation mean to excite the light emitting elements to produce flash light altered in intensity according to either one of an effective focal length and an F-number of the taking lens.

The lighting pattern directive means may direct the selective excitation mean to excite selectively the light emitting elements to produce flash light in predetermined different lighting patterns according to subject distances. In this instance, the lighting pattern directive means doubles as ranging means and/or as a manually operable mode setting member for setting the taking lens to a macro-mode (close-up mode). The raging means are known in various form and may take any form well known in the art. This configuration avoids a parallax between a field of views of the taking lens 110 and the image pickup device due to positional displacement therebetween that depends upon the subject distance.

The lighting pattern directive means may further direct the selective excitation mean to excite selectively the light emitting elements to produce flash light in different lighting patterns for purposive pre-lighting for automatic focusing convenience, determination of emission intensity for flash photo shooting, or elimination or alleviation of a red-eye effect. The lighting pattern directive means is preferred to direct the selective excitation mean that the selected light emitting elements produce flash light at intensity for the purposive pre-lighting than for flash photo shootings. According to this configuration, the lighting unit produces flash light efficiently toward a restricted field effective only for the purposive pre-lighting.

The photographic equipment may further comprise optical communication means for making optical communication with external equipments. In this instance, the lighting pattern directive means directs the selective excitation mean to excite the light emitting elements to produce flash light in a specific lighting pattern for optical communication. This configuration causes the lighting unit to produce flash light efficiently for optical communication.

### BRIEF DESCRIPTION OF THE DRAWINGS

The foregoing and other objects and features of the present invention will be clearly understood from the following detailed description when reading with reference to the accompanying drawings, wherein the same reference signs have been used to denote same or similar parts throughout the drawings, and in which:

FIG. 1 is a schematic view of a part of a photographic equipment according to an embodiment of the present invention for showing a physical relationship between a taking lens and a matrix arrangement of light emitting diodes of a lighting unit;

FIG. 2 is a block diagram of an internal structure of the lighting unit;

FIG. 3 is an illustration showing selective excitation patterns of light emitting diodes for various predetermined lighting patterns;

FIG. 4A is an illustration showing selective excitation patterns of light emitting diodes for various predetermined lighting patterns of an alternate matrix arrangement of light emitting diodes of the lighting unit;

FIG. 4A is a diagram showing an excitation circuit for selectively exciting the alternate matrix arrangement of light emitting diodes;

FIGS. 5A and 5B are diagrams showing variations of the an excitation circuit;

FIG. 6 is a block diagram showing an overall structure of a photographic equipment according to another embodiment of the present invention; and

FIG. 7 is a chart illustrating a photographic process of the photographic equipment

### DETAILED DESCRIPTION OF THE PREFERRED EMBODIMENTS

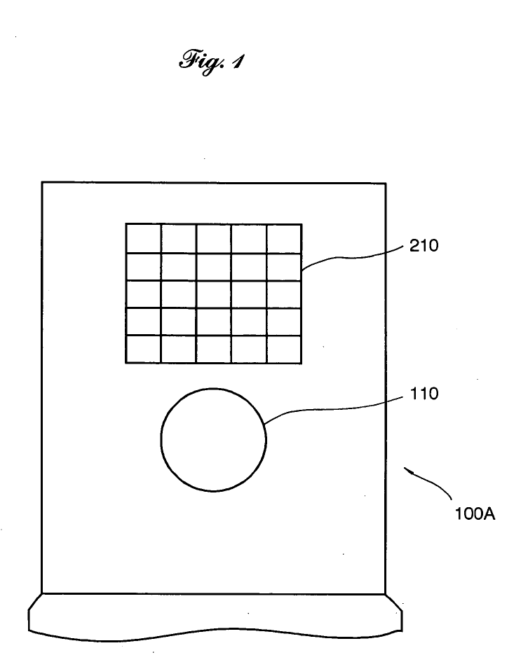

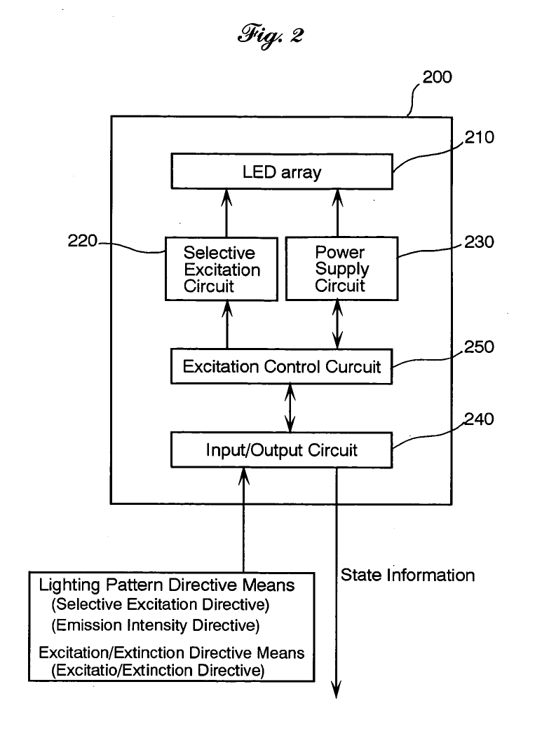

Referring to the accompanying drawings in detail, and in particular, to FIG. 1 schematically showing a photographic equipment, namely an image importable cellular phone 100A according to an embodiment of the present invention, the cellular phone 100A includes a taking lens 110 forming part of an image pickup system and an array of light emitting diodes (LEDs) (which is hereinafter referred to as an LED array) 210 forming part of a built-in lighting unit 200 (see FIG. 2) for producing subsidiary flash light which are installed into a top cover of the cellular phone 100A. that is aimed at subjects when opened. The LED array 210 comprises a number of white LED element arranged in a matrix pattern. These white LED elements have lighting axes different from one another so as to produce light toward different areas of a field of view of the taking lens 110, respectively. All of the incident light falling on the scene which includes available light, indoor illumination light, other ambient light and flash light from the white LED array 210, is reflected by objects and enters an image pickup device such as a charge coupled device (not shown) of the cellular phone 100A through the taking lens 110. The white LED element is known in various types such as a single chip type comprising a single white LED chip or segment and a combination type comprising three primary color LED segments, namely red, green and blue LED segments, which emit constituent primary color light, namely red, green and blue light, respectively. The combination type LED element can form a wide range of colors according to color temperatures of ambient light by adjusting proportions of light of the three primary colors. When the combination type LED element produces a beam of light containing a relatively even mixture of light of the three primary colors, it is seen as white. The LED array 210 shown in FIG. 1 by way of example includes, but not bounded by, 30 white LED elements, single chip type or combination type, arranged in a 6×5 matrix pattern. In the following description, the LED array 210 is described as comprising 30 single chip type white LED elements for descriptive expedient and, occasionally described as comprising more or less than 30 single chip type white LED elements.

Referring to FIG. 2 illustrating an internal configuration of the lighting unit 200 having the LED array 210, the lighting unit 200 comprises primarily a circuit 220 as selective excitation means, a power supply circuit 230, an input/output circuit 240 and a circuit 250 as excitation/extinction control means in addition to the LED array 210. The selective excitation circuit 220 excites selectively the white LED elements so as to produce flash light in desired lighting patterns and extinguishes them. The power supply circuit 230 supplies a predetermined excitation voltage to the selected white LED elements. Each of the white LED elements has a forward voltage of, for example, 3.4 V that is higher than a voltage of 1.5 V of general dry batteries, so, in the case where the white LED elements are connected in series, it is difficult to excite the white LED elements directly with the voltage of dry batteries. Therefore, the power supply circuit 230 has a configuration operative to boost an input voltage (a voltage of batteries) and to supply it to the white LED element. Further, the power supply circuit 230 carries out a function of supplying a voltage stabilized correspondingly to a drop in forward voltage between opposite terminals of the while LED element with noises reduced as low as possible. Furthermore, the power supply circuit 230 has a control terminal for controlling an electric current applied to the individual white LED elements. The electric current applied to the individual white LED elements from the selective excitation/extinction control circuit 250 is varied through the control terminal so as thereby to vary emission intensity or quantity of the individual white LED elements.

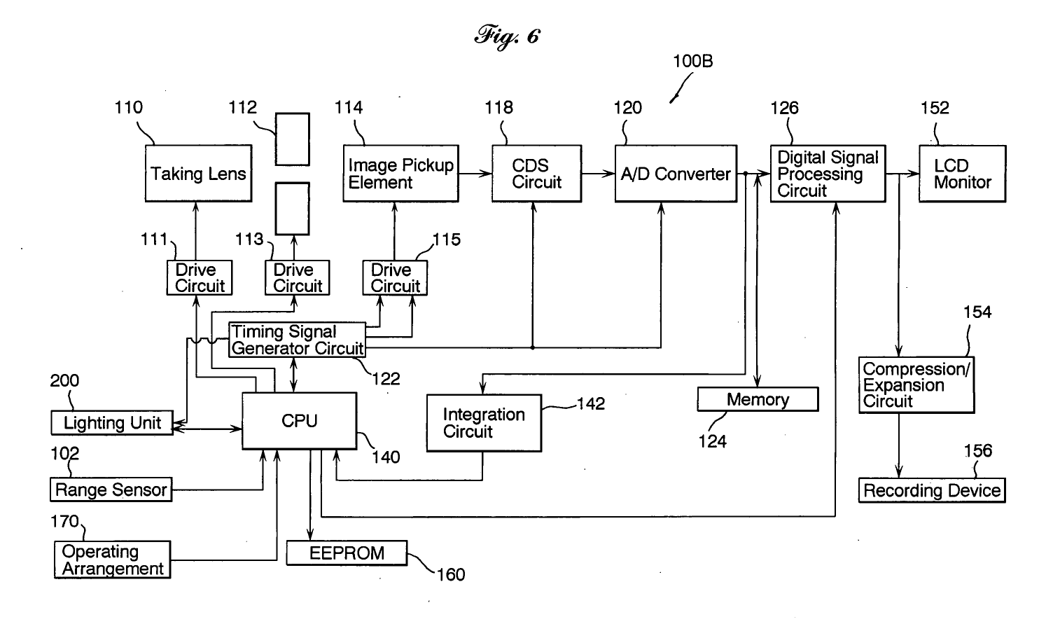

The input/output circuit 240 receives various directive signals from a central processing unit (CPU) 140 (see FIG. 6) which will be described later and, on the other hand, provides state information signals representing the present state of the lighting unit 200 for the CPU 140. Examples of the directive signals include, but not limited to, at least a directive signal indicating which white LED elements should be exited, a directive signal indicating emission intensity of the white LED element, a directive signal indicating timings of excitation and extinction of the white LED elements, and a zoom position directive signals such as a wide-angle position directive signal, a telephoto position directive signal or a macro position) The incoming directive signals are transferred to the excitation/extinction control circuit 250. It is of course desirable to include preparatory directive signals such as a charge start directive signal and preparatory state information signals such as an on-charge state signal and a ready state signal, as appropriate.

The excitation/extinction control circuit 250 controls the selective excitation circuit 220 and the power supply circuit 230 according to the directive signals sent thereto through the input/output circuit 240. A lighting pattern or lighting extent of the lighting unit 200 is altered by controlling the selective excitation circuit 220 so as to excite selectively the white LED elements. Emission intensity of the individual white LED elements is varied by controlling the power supply circuit 230 through its control terminal to vary the electric current applied to the individual white LED elements. Alternatively, emission intensity of the individual white LED elements may be varied by controlling the selective excitation circuit 220 so as to vary electric resistance of its resistive potential divider, thereby varying a voltage applied to the white LED elements. Further, the excitation control circuit 250 may control the selective excitation circuit 220 so as to vary excitation and extinction timings of the white LED elements according to excitation and extinction directive signals, respectively, sent from the input/output circuit 240.

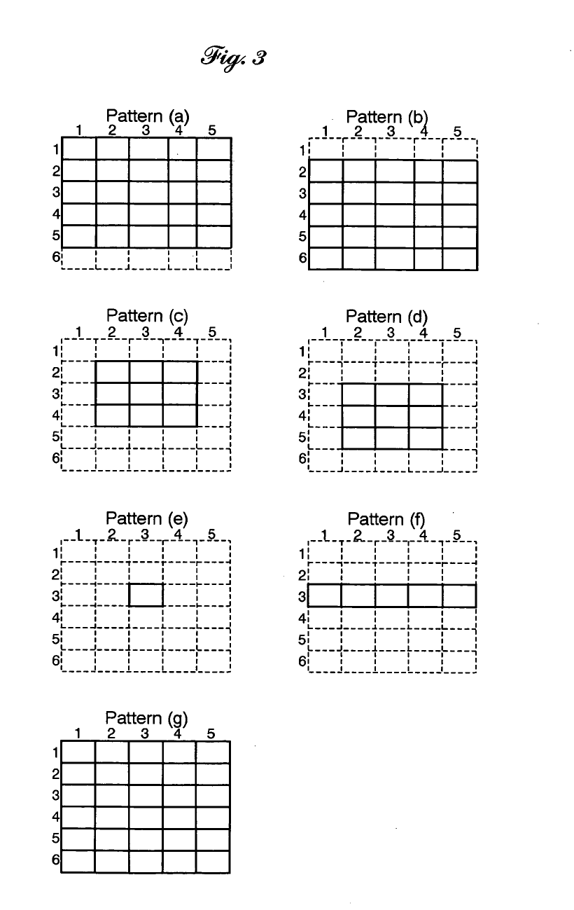

FIG. 3 shows various predetermined lighting patterns, in other words excitation patterns, of the LED array 210 comprising 30 white LED elements arranged in a 6×5 matrix by way of example. Rows and columns of the matrix are numbered in ascending order from top to bottom and from left to right, respectively. Matrix elements edged with a heavy-line represent excited white LED elements, respectively. There are two ways of selective excitation, namely individual excitation and collective excitation. In the case where the individual excitation is employed, all of the white LED elements are parallelized to a string of 30 bits one-on-one. Taking a lighting or excitation pattern (c) shown in FIG. 3 for instance, the lighting pattern (c) of the LED array 210 is defined by predetermined bit string data which includes the binary digit 1 for excitation of the white LED elements lying in the second to third rows between the second to fourth columns, respectively. On the other hand, in the case of the collective excitation, pattern data are prepared for available lighting or exciting patterns (a) to (g), respectively. When an excitation pattern directive signal desiring a specific lighting or excitation pattern is sent to the input/output circuit 240, the white LED elements included in the desired exciting pattern are collectively excited. In either excitation, the lighting unit 200 does not allow all of the white LED elements to remain continuously excited but excites the selected white LED elements at an intended timing to produce flash light at desired intensity for a necessary duration

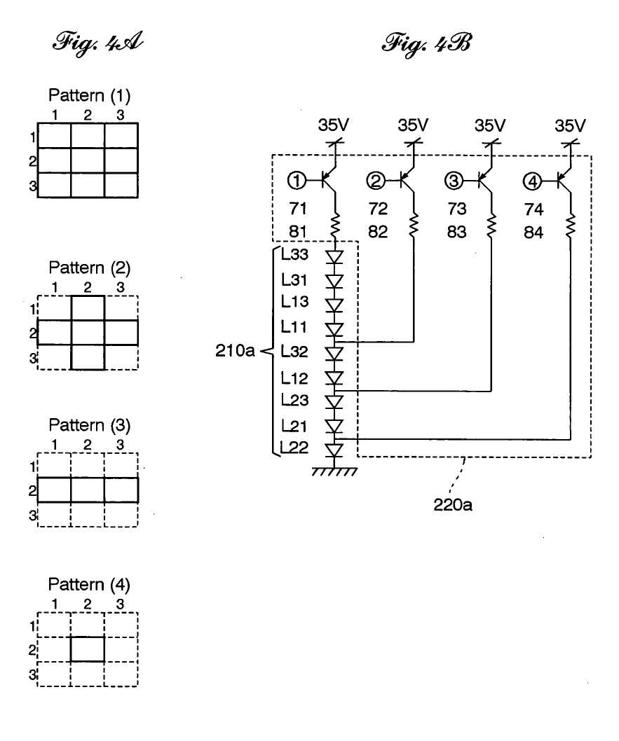

FIG. 4A is an illustration showing lighting or excitation patterns o an alternate LED array 210a. The LED array 210a comprises nine white LED elements Lₘₙ (m (row)=1, 2, 3; n (column)=1, 2, 3) arranged in a 3×3 matrix. FIG. 4(B) is a circuit diagram of the selective excitation circuit 220a for selectively exciting the white LED elements Lₘₙ. The nine white LED elements Lₘₙ are electrically connected in series in the order programmed, for example, as shown in FIG. 4(B). The selective excitation circuit 220 comprises first to fourth switching transistors 71 to 74 and first to fourth resistive potential divider 81 to 84 having resistance different from one another. Each switching transistor is connected to the power supply circuit 230 at its emitter and to the selective excitation circuit 250 at its base.

The resistive potential dividers 81 to 84 are connected to bases of the switching transistors 71 to 74, respectively, at their one ends and to specified positions of a series of the white LED elements Lₘₙ. More specifically, the first resistive potential divider 81 is connected to the first switching transistor 71 at one of its opposite ends and to the top white LED element in the series array, namely the ninth white LED element L₃₃, at its another end. The second resistive potential divider 82 is connected to the second switching transistor 72 at one of its opposite ends and to a juncture between adjacent white LED elements, the fourth and the fifth from the top in the series array, namely the first white LED element L₁₁ and the eighth white LED element L₃₂ at its another end. The third resistive potential divider 83 is connected to the third switching transistor 73 at one of its opposite ends and to a juncture between adjacent white LED elements, the sixth and the seventh from the top in the series array, namely the second white LED element L₁₂ and the sixth white LED element L₂₃ at its another end. The fourth resistive potential divider 84 is connected to the fourth switching transistor 74 at one of its opposite ends and to a juncture between adjacent white LED elements, the eighth and the ninth from the top in the series array, namely the fourth white LED element L₂₁ and the fifth white LED element L₂₂ at its another end. The switching transistors 71 to 74 receive on/off signals, respectively, from the excitation control circuit 250 so as to be put conductive or nonconductive. The resistive potential dividers 81 to 84 divide voltage supplied from the power supply circuit 230 so as to energize selected white LED elements with specified voltages, respectively.

In order to keep an electric current sent to the individual white LED elements constant regardless of the number of white LED elements to be excited, the resistive potential dividers 81 to 84 should have a resistance (i) satisfying the following expression (I):
R(i)=(V₀−Vf×n(i))/I (I)
where i (i=1, 2, 3, 4) is an identification number of the switching transistor and the resistive potential divider;
   V₀ is the rated voltage of the power supply circuit 230 (for example 35 V);
   Vf is the rated forward voltage of the white LED element (for example 3.4 V);
   n(i) is the number of white LED elements to be excited;
   R(i) is the resistance of the resistive potential divider;
   I is the constant current applied to the white LED element (for example 15 mA).

According to the configuration of the selective excitation circuit 220a, when the first switching transistor 71 is put conductive, all of the white LED elements L₁₁ to L₃₃ are excited to emit light in a lighting pattern (1), namely a full extent lighting pattern, as shown in FIG. 4(A). When the second switching transistor 72 is put conductive, five white LED elements L₁₂, L₂₁, L₂₂, L₂₃, and L₃₂ are excited to emit light in a lighting pattern (2), namely a cruciform lighting pattern, as shown in FIG. 4(A). When the third switching transistor 73 is put conductive, three white LED elements L₂₁, L₂₂, and L₂₃ lying in the middle row are excited to emit light in a lighting pattern (3), namely a central strip lighting pattern, as shown in FIG. 4(A). When the fourth switching transistor 74 is put conductive, only a center white LED element L₂₂ is excited to emit light in a lighting pattern (4), namely a center spot lighting pattern, as shown in FIG. 4(A).

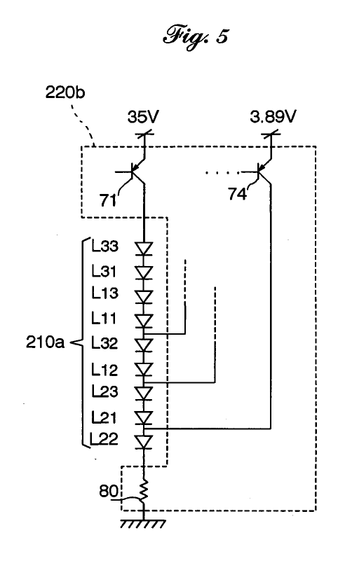

FIG. 5 shows an alternate selective excitation circuits 220b. The selective excitation circuit 220b comprises the same arrangement of switching transistors 71 to 74 as the selective excitation circuit 220a shown in FIG. 4(B) and a common resistive potential divider 80. The second and the third switching transistors are omitted for illustration simplicity in Figure. The connecting configuration of the switching transistors 71 to 74 relative to the white LED array 210a is exactly the same as the selective excitation circuit 220a.

In order to keep an electric current sent to the individual white LED elements constant regardless of the number of white LEDs to be excited, the resistive potential dividers 81 to 84 should have a resistance (i) satisfying the following expression (II):
R(i)=Vf×n(i)+R×I (II)
where i (i=1, 2, 3, 4) is an identification number of the switching transistor and the resistive potential divider;
   Vf is the rated forward voltage of the white LED element (for example 3.4 V);
   n(i) is the number of white LED elements to be excited;
   R is the resistance of the common resistive potential divider;
   I is the constant current applied to the white LED element (for example 15 mA).

With reference to FIG. 6 showing an internal configuration of a photographic equipment, namely a digital still camera 100B according to another embodiment of the present invention that is equipped with a lighting unit 200 such as described in connection with the previous embodiment, the digital still camera 100B comprises, in addition to the lighting unit 200, an image pickup system comprising basically a taking lens 110 preferably both having optical and electronic zooming features, an aperture diaphragm 112 and an image pickup device 114 such as charge coupled device (CCD), a range sensor 102, a lens drive circuit 111, a diaphragm drive circuit 113, an image pickup device driver circuit 115, a correlation double sampling circuit (CDS circuit) 118, an A/D converter 120, a timing signal generator circuit 122, a memory 124, a digital signal processing circuit 126, CPU 140, an integrating circuit 142, a liquid crystal device (LCD) monitor 152, a data compression/expansion circuit 154, a recording device 156, EEPROM 160 and an operating arrangement 170. All of the incident light falling on the scene, which includes available light, indoor illumination light other ambient light and artificial light produced as appropriate by the lighting unit 20, is reflected by objects and enters the image pickup device 114 through the taking lens 110 and the aperture diaphragm 112 to form an optical image on the image plane of the image pickup device 114. The image pickup device 114 comprises a considerably large number of photosensors arranged in a two-dimensional configuration The photosensors convert optical images formed thereon into electric charges proportional to intensity of incident light thereon and store the electric charges. The stored electric charges are outputted in the form of analog image signals with timing signals provided by the timing signal generator circuit 122 and then are sampled and held by the CDS circuit 118 by pixel. The analog image signals are sent to the A/D converter 120 for analog-to-digital conversion. The digital image signals are further sent to the digital signal processing circuit 118 after having been stored in the memory 124 once. The image pickup device driver circuit 115, CDS circuit 118 and A/D converter 120 are synchronized with timing signals from the timing signal generator circuit 122 so as to output digital image signals in a dot sequential system to the digital signal processing circuit 126.

The digital signal processing circuit 126 converts the digital image signals into the form of simultaneous system from the form of dot sequential system and then into Y and C signals (brightness signals Y and Color difference signals Cr and Cb) after gamma correction and white balance correction. The digital image signals are subsequently sent to and displayed as an image on LCD monitor 152 and, on the other hand, are sent to the data compression/expansion circuit 154 for image data compression on a specified format and thereafter to the recording device 156 for write to a memory medium such as a memory card. When the digital still camera 100B is put in a playback mode, the image data is read out from the memory medium and is expanded into digital image signals by the data compression/expansion circuit 154 for display on LCD monitor 152.

The operating arrangement 170 is provided with various manually operable buttons including, but not limited to: a mode switch-over button for switching over the digital still camera 100B among available operational modes including, for example, a photographic mode, a playback mode, an optical communication mode, etc; a zoom button for inputting a directive signal for zooming, a shooting or shutter button for inputting a preparatory directive signal for bringing the digital still camera 100B into the ready and subsequently a shooting directive signal for making exposure; and other buttons for inputting various directive signals as appropriate.

CPU 140 overall controls the digital still camera 100B according to incoming directive signals through the manually operable buttons of the operating arrangement 170 and, on the other hand, performs various calculations of automatic control parameters appertaining to automatic focusing (AF), automatic exposure (AE), automatic white balance correction (AWB), etc.

The automatic focusing of the digital still camera 100B is performed by depressing the shooting or shutter button half-way so as thereby to input a preparatory directive signal. Upon the half-way depression of the shooting or shutter button, the range sensor 102 is instantaneously activated to find a subject distance, then, the lens drive circuit 111 causes the taking lens to move automatically to a point where it focuses a sharp image of the aimed subject on the image plane of the image pickup device 114. Thereafter, exposure is made by gently pressing the shooting or shutter button all the way down. In the event where the incident light falling on the scene and reflected by an object in the scene is too low in intensity to make correct range finding, the lighting unit 200 may be activated to make pre-lighting for automatic focusing convenience. Another way to make automatic focusing is a contrast automatic focusing technique. In this technique, CPU 140 controls the lens drive circuit 111 to cause the taking lens 110 to move to a point where a high frequency component of a signal of green (G signal) is maximized.

The automatic exposure begins when depressing the shooting or shutter button half-way. That is, CPU 140 finds a brightness value according to a subject brightness that is obtained from intensity of three primary color (R, G and B) light integrated respectively by the integrating circuit 142. As well known in the art, a proper combination of shutter speed and aperture is automatically determined. CPU 140 causes the diaphragm drive circuit 113 to open the aperture diaphragm 112 to the size of aperture immediately, and causes the image pickup device driver circuit 115 to drive the image pickup device 114 at a speed equivalent to the shutter speed immediately when pressing the shooting or shutter button all the way down. In the event where the incident light falling on the scene and reflected by an object in the scene is too low in intensity to make correct exposure, the lighting unit 200 is activated to make automatic flush exposure.

The automatic white balance correction is made according to a color temperature. CPU 140 finds three primary color temperatures for a plurality of divisional sections of the image plane of the image pickup device 114 on the basis of intensity of the three primary color light respectively integrated by the integrating circuit 142 and calculates values for white balance correction for image signals of the three primary colors. Then, the digital image signals are corrected by color according to the white balance correction values by the digital signal processing circuit 126.

The lighting unit 200 is controlled with various directive signals, such as an excitation pattern directive signal indicating which white LED elements should be excited, an emission intensity directive signal for adjusting emission intensity of the selected white LED elements, an excitation directive signal for excitation of the selected white LED elements and an extinction directive signal for extinguishing the white LED elements, from CPU 140.

The selective excitation of white LED elements is performed in two ways according to zooming systems, optical and electronic. Specifically, in the event of using an optical zooming system in which zooming is performed by varying a focal length of the taking lens 110 through manual operation of the zoom button of the operating arrangement 170, a lighting extent of the lighting unit 200 is determined correspondingly to a field of view of the taking lens 110 that is found from an effective focal length. The term “effective focal length” as used herein shall mean and refer to the focal length of a zoom lens in a present zoom position CPU 140 sends the lighting unit 200 an excitation pattern directive signal indicating which white LED elements should be excited in order to cover the lighting extent sufficiently enough. For example, when the taking lens 110 is set to its wide-angle position, the lighting unit 200 is controlled to produce flash light in the lighting pattern (a) shown in FIG. 3 by exciting all of the white LED elements in the first to fifth rows when receiving an excitation directive signal indicating the wide-angle position (zoom ratio). On the other hand, when the taking lens 110 is set to its telephoto position (zoom ratio), the lighting unit 200 is controlled to produce flash light in the lighting pattern (c) shown in FIG. 3 by exciting white LED elements lying in the second to fourth rows between second and fourth columns when receiving an excitation directive signal indicating the telephoto position (zoom ratio).

In the event of using an electronic zooming system in which zooming is performed by extracting a desired part of an optical image formed on the image plane of the image pickup device 114, a lighting extent of the lighting unit 200 is determined correspondingly to an extracted area of the image plane of the image pickup device 114, more specifically, an electronic zoom ratio (a ratio of an extraction area relative to an available area of the image plane). CPU 140 sends the lighting unit 200 an excitation pattern directive signal indicating the electronic zoom ratio, namely which white LED elements should be excited. For example, in the event where the electronic zoom is further performed from the telephoto position, CPU 140 sends the lighting unit 200 an excitation pattern directive signal for exciting only the white LED element at a 3-3 element of the 6×5 matrix so as thereby to produce flash light in a lighting pattern (e) shown in FIG. 3.

In order to avoid parallax between the taking lens 110 and the LED array 210 that occurs due to a change in subject distance, CPU 140 determines which white LED elements should be exited according to subject distances. Specifically, the most common practice is to determine white LED elements to be excited on the basis of a subject distance found by the range sensor 102. Alternate way to determine which white LED elements should be excited is to refer whether or not the macro or close-up mode has been set through manual operation of the mode switch button. For example, when the mode setting member is operated to set the taking lens 110 to a macro-mode (close-up mode) in a state where the lighting pattern (c) shown in FIG. 3 is appropriately selected, CPU 140 sends the lighting unit 200 an excitation pattern directive signal for exciting the white LED element lying in third to fifth rows between the second to fourth columns of the 6×5 matrix so as thereby to produce flash light in a lighting pattern (d) shown in FIG. 3 which is just the same in terms of shape as, but different in position relative to the field of view of the taking lens from, the lighting pattern (c).

In the event where the pre-lighting is intended before flash photo shooting, the lighting unit 200 is controlled so as to produce flash light in predetermined different lighting patterns according to intended purposes. Examples of the pre-lighting purposes includes, but not limited to, automatic focusing convenience, elimination or alleviation of a red-eye effect, determination of emission intensity for flash photo shooting, etc. In the case where the lighting unit 200 casts flash light in, for example, the lighting pattern (a) shown in FIG. 3 by exciting all white LED elements lying in the first to fifth rows for flash photo shooting, the lighting unit 200 is controlled to produce flash light in the lighting pattern (f) for automatic focusing by exciting all white LED elements lying in the third row, or in the lighting pattern (c) for elimination or alleviation of a red-eye effect by exciting white LED elements lying in the third to fourth rows between the second and fourth columns. In this instance, the pre-lighting pattern for automatic focusing is designed so as to cast flash light directed toward a restricted part in a scene congruous with the target field of measurement of the range sensor 102. The pre-lighting pattern for elimination or alleviation of a red-eye effect is designed so as to cast flash light at and around eyes of a person standing in a scene.

The lighting unit 200 has a function of optical communication with external equipments. For optical communication, the lighting unit 200 is controlled to cast flash light at a restricted area. When the mode switch-over button of the operating arrangement 170 is operated to set the digital camera 200B to the optical communication mode, CPU 140 sends the lighting unit 200 an excitation pattern directive signal for exciting only the white LED element lying at a 3-3 element of the 6×5 matrix so as thereby to cause the lighting unit 200 to produce flash light in the lighting pattern (e).

The lighting unit 200 is further controlled in emission intensity for purposive pre-lighting and flash photo shooting. CPU 140 sends the lighting unit 200 an emission intensity directive signal indicating emission intensity at which the white LED elements emit white light along with an excitation directive signal for flash photo shooting. The lighting unit 200 changes the lighting pattern and the emission intensity at the same instance upon reception of the excitation pattern directive signal and the emission intensity directive signal for flash photo shooting. The emission intensity directive signal is provided according to an F-number, an effective focal length or a zoom position of the taking lens 110. In this instance, the relationship between emission intensity and F-numbers (which may be replaced with focal length or zoom position) is stored in the form of a lookup table in EEPROM 160 beforehand. Therefore, emission intensity with respect to an F-numbers found from the effective focal length or the zoom position is found with reference to the lookup table. It is well known in the art that a numerical value, namely F-number (Fₙₒ), representing the light-gathering ability of a lens can be obtained from a fraction f/D, where F is the focal length and D is the effective aperture. An F-number relative to an effective focal length can be figured out from the expression Fₙₒ=f/D. It is preferred that the emission intensity stored in makes brightness per unit acceptance area of an image falling on the image pickup device 114 constant regardless of effective focal lengths.

Further, CPU 140 sends the lighting unit 200 an emission intensity directive signal indicating emission intensity at which the white LED elements emits light along with an excitation directive signal for purposive pre-lighting by purpose, namely automatic focusing convenience, elimination or alleviation of red-eye effect or determination of lighting intensity for flash photo shooting. Emission intensity is found with reference to a lookup table of the relationship between emission intensity and pre-lighting purposes that is stored in EEPROM 160 beforehand. The lighting unit 200 changes the lighting pattern and the emission intensity at the same instance upon reception of the excitation pattern directive signal and the emission intensity directive signals for purposive pre-lighting.

The lighting unit 200 is controlled in duration with excitation and extinction timings with the intention of power saving. For the reason that the pre-lighting is generally allowed to be shorter in duration as against lighting for flash photo shooting, CPU 140 sends the lighting unit 200 excitation and extinction directive signals so that the lighting device runs for a duration upon the purposive pre-lighting shorter than upon lighting for flash photo shooting. In this instance, CPU 140 sends excitation and extinction directive signals so as that the image pickup device 114 starts and terminates storage of charges, respectively. Further, if the lighting unit 200 has need to be excited after completion of charging, excitation of the lighting unit 200 is controlled to start after reception of a ready state information signal representing that the lighting unit 200 has bee charge sufficiently enough to light.

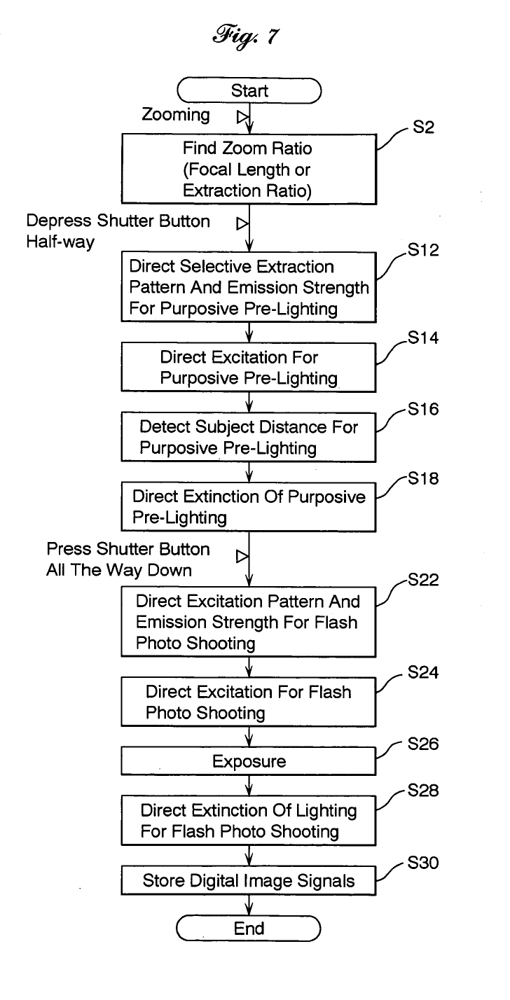

FIG. 7 is a chart illustrating a photographic process of, for example, taking a still image by the digital still camera 100B shown in FIG. 6. At the beginning of the photographic process, when the zoom button is operated for optical zooming or electronic zooming, CPU 140 finds a zoom ratio, i.e. an effective focal length in the case of optical zooming or a ratio of an extraction or trimming area of the image pickup device 114 on which a desired part of an image falls relative to a given image area of the image pickup device 114 in the case of electronic zooming (step S2). If both optical zooming and electronic zooming are intended, CPU 140 finds these zooming parameters, a focal length and an extraction area. Subsequently, when the shutter button is depressed half-way, CPU 140 provides an excitation pattern directive signal and an emission intensity directive signal for purposive pre-lighting for the lighting unit 200 (step S12) and further an excitation directive signal to excite the lighting unit 200 (step S14) in the event where the subject has need to be lit with subsidiary light for clear focusing. The lighting unit 200 excites white LED elements selected on the basis of the excitation pattern directive signal to light the subject in the lighting pattern (f) shown in FIG. 3 at an intensity prescribed by the emission intensity directive signal. During the pre-lighting, the range sensor 102 detects a subject distance (step S16). Immediately thereafter, CPU 140 provides an extinction directive signal for the lighting unit 200 so as to allow the lighting unit 200 to run for duration of lighting shorter than duration of lighting for flash photo shooting (in step S18). Thereafter, CPU 140 manages to determine an exposure value (EV), to cause the taking lens 112 to focus automatically on the subject and to correct white balances of digital image signals.

When the shutter button is pressed all the way down, CPU 140 provides an excitation pattern directive signal and an emission intensity directive signal for practical lighting for the lighting unit 200 (step S22) and further an excitation signal to excite the lighting unit 200 (step S24) in the event where the subject has need to be lit with subsidiary light for exposure. Specifically, while the lighting unit 200 runs with white LED elements selected and exited to light the subject in the selected lighting pattern prescribed by the excitation pattern directive signal at an intensity prescribed by the emission intensity directive signal, an exposure is completed (step S26). The lighting pattern of the lighting unit 200 is determined depending upon the currently set focal length or an extraction area of the image pickup device 114 and a subject distance. The lighting intensity is determined depending upon the subject distance or an F-number. After completion of exposure, CPU 140 provides an extinction directive pattern signal for the lighting unit 200 so as to force the lighting unit 200 to extinguish immediately (step S28).

If the purposive pre-lighting for elimination or alleviation of red-eye effect is called for by entering a purposive pre-lighting directive through the operating arrangement 170, the pre-lighting is performed before the preparatory operation of the lighting unit 200 (step S22).

At the tail of the process of the photographic process, digital image signals converted from an optical image by the image pickup device 114 are temporarily stored in the memory 124 (step S30) and, sent to the LCD monitor 152 to display an image corresponding to the digital image signals on request and/or sent to the recording device 156 for write to a memory card through the data compression/expansion circuit 154 on request.

Although the present invention has been described in conjunction with a digital camera by way of exemplary application, it is embodied in digital video cameras and cellular phones, and even in conventional cameras for use with silver films. Further, various other embodiments and variants may occur to those skilled in the art, which are within the scope and spirit of the invention, and such other embodiments and variants are intended to be covered by the following claims.

1. A lighting unit for producing flash light toward a subject in a photographic scene comprising:
a plurality of light emitting elements arranged so as to have individual lighting fields different from one another;
selective excitation mean for exciting selectively said light emitting elements so as to produce flash light in predetermined lighting patterns.

2. The lighting unit as defined in claim 1, wherein said light emitting element consists of a light emitting diode.

3. The lighting unit as defined in claim 1, wherein said selective excitation mean further excites said light emitting elements to produce flash light altered in intensity.

4. A photographic equipment comprising:
an image pickup system operative to form an optical image of a subject on an image pickup device through a taking lens, said image pickup system having at least one of optical and electronic zooming features;
a lighting unit comprising for producing flash light toward the field of view of the image pick up system, said lighting unit comprising a plurality of light emitting elements arranged so as to have individual lighting fields different from one another;
selective excitation mean for exciting selectively said light emitting elements to produce flash light in predetermined different lighting patterns; and
lighting pattern directive means for directing said selective excitation mean to excite selectively said light emitting elements to produce flash light in different lighting patterns.

5. The photographic equipment as defined in claim 4, wherein said light emitting element consists of a light emitting diode.

6. The photographic equipment as defined in claim 5, wherein said selectively exciting mean further changes intensity of light that each said light emitting element emits.

7. The photographic equipment as defined in claim 6, wherein said lighting pattern directive means directs said selective excitation mean to excite selectively said light emitting elements to produce flash light in predetermined different lighting patterns according to at least one of adopted optical and electronic zoom ratios of said image pickup system.

8. The photographic equipment as defined in claim 7, wherein said lighting pattern directive means further directs said selective excitation mean to excite said light emitting elements to produce flash light altered in intensity according to one of an adopted focal length and an F-number of said taking lens.

9. The photographic equipment as defined in claim 4, wherein said lighting pattern directive means directs said selective excitation mean to excite selectively said light emitting elements to produce flash light in predetermined different lighting patterns according to subject distances.

10. The photographic equipment as defined in claim 4, wherein said lighting pattern directive means further directs said selective excitation mean to excite selectively said light emitting elements to produce flash light in different lighting patterns for purposive pre-lighting for at least automatic focusing convenience, determination of lighting intensity for flash photo shooting, or elimination or alleviation of red-eye effect.

11. The photographic equipment as defined in claim 10, wherein said lighting pattern directive means directs said selective excitation mean to excite said light emitting elements to produce flash light at intensity for said pre-lighting lower than for said flash photo shooting.

12. The photographic equipment as defined in claim 4, and further comprising an optical communication means for making optical communication with external equipments, wherein said lighting pattern directive means directs said selective excitation mean to excite said light emitting elements to produce flash in a specific lighting pattern for optical communication.
